(19) United States
(12) Patent Application Publication
(10) Pub. No.: US 2015/0276168 A1
(43) Pub. Date: Oct. 1, 2015

(54) DEVICE FOR PROVIDING ELECTROMAGNETIC RADIATION HAVING A PREDEFINED TARGET RADIATION DISTRIBUTION, AND METHOD FOR PRODUCING A LENS ARRANGEMENT

(71) Applicant: OSRAM GmbH, Muenchen (DE)

(72) Inventors: Stephan Malkmus, Puchheim (DE); Tobias Schmidt, Augsburg (DE)

(21) Appl. No.: 14/409,498

(22) PCT Filed: Jun. 28, 2013
(86) PCT No.: PCT/EP2013/063739

§ 371 Date: Dec. 19, 2014

(30) Foreign Application Priority Data
Jul. 3, 2012 (DE) 10 2012 211 555.2

(51) Int. Cl. F21V 5/04; F21K 99/00

(52) U.S. Cl. CPC F21V 5/04; F21V 5/045; F21K 9/50; F21Y 2101/02

(57) ABSTRACT

Various embodiments relates to a device for providing electromagnetic radiation having a predefined target radiation distribution. The device has a lens arrangement and a radiation arrangement for generating electromagnetic radiation to be deflected including a predefined source radiation distribution. The lens arrangement has a first and a second lens. The first lens has a first and a second boundary surfaces. The first boundary surface is concave and the second boundary surface is convex. The first boundary surface forms a first recess. The second lens has a third and a fourth boundary surfaces. The third boundary surface is concave and the fourth boundary surface is convex. The third boundary surface forms a second recess, in which at least part of the first lens is arranged. The radiation arrangement is arranged such that at least part of the electromagnetic radiation to be deflected enters the lens arrangement via the first boundary surface.

### RELATED APPLICATIONS

The present application is a national stage entry according to 35 U.S.C. §371 of PCT application No.: PCT/EP2013/063739 filed on Jun. 28, 2013, which claims priority from German application No.: 10 2012 211 555.2 filed on Jul. 3, 2012, and is incorporated herein by reference in its entirety.

### TECHNICAL FIELD

Various embodiments may generally relate to a device for providing electromagnetic radiation having a predefined target radiation distribution. The device includes a radiation arrangement for generating radiation including a predefined source radiation distribution and at least one lens. Furthermore, various embodiments may relate to a method for producing a lens arrangement.

### BACKGROUND

Devices for providing electromagnetic radiation are known wherein a radiation source which emits electromagnetic radiation is assigned one or more lenses which shape the electromagnetic radiation. The emitted electromagnetic radiation can have a radiation distribution which is typical of the radiation source used and which can for example also be designated as source radiation distribution. The lenses can contribute to altering the source radiation distribution and thus generating a target radiation distribution. In the case of conventional flashlights, for example, the source radiation distribution of light from small incandescent lamps, which often have an omnidirectional emission characteristic, is converted into a directional target radiation distribution by means of specularly reflective surfaces and lenses. The radiation distributions can be characterized for example by radiance distributions or by cumulative luminous flux distributions, wherein a cumulative luminous flux distribution corresponds to the integral over a radiance distribution.

Nowadays, as radiation sources, conventional incandescent lamps are being replaced more and more often by light emitting diodes, for example LEDs or OLEDs. Light emitting diodes are in principle surface light sources and/or surface emitters and often have a Lambertian emission characteristic, wherein the emitted radiation is emitted into a half-space defined by the emissive surface of the light emitting diode.

FIG. 1 shows a Lambertian radiance distribution 10 plotted in a solid angle diagram. The radiance distribution 10 forms a circle between 90° and −90°, wherein the circle is tangent to the origin of the solid angle diagram.

In some applications, however, it is desirable for one or more light emitting diodes to be used as radiation source and for a uniform target radiation distribution, for example an omnidirectional target radiation distribution, to be able to be generated by the device for providing the radiation which includes the radiation source, and/or for the device to have an omnidirectional emission characteristic. These applications include incandescent lamp retrofits, for example, which have the external appearance of incandescent lamps in operation, but include light emitting diodes as radiation sources. In this case, it should be noted that in this connection “omnidirectional” means that the radiance distribution is uniform or at least substantially uniform in a large solid angle range, for example in a solid angle range of 150° to −150°, for example of 130° to −130°. The fact that the radiance distribution is uniform can mean, for example, that for all source angles of the electromagnetic radiation the ratio of the radiance at one of the source angles to the average radiance is for example between 0.3 and 3.0, for example between 0.5 and 2.0, for example between 0.8 and 1.2.

FIG. 2 shows a uniform radiance distribution 12, for example one which can be designated as an omnidirectional radiance distribution and/or one which complies with the known mark of quality (benchmark) “EnergyStar”.

It is known to convert the Lambertian radiance distribution 10 shown in FIG. 1 into the omnidirectional radiance distribution shown in FIG. 2, for example with the aid of segmented optical systems, with the aid of 3D arrangements of light emitting diodes, with the aid of application of the remote phosphor concept and/or with the aid of optical waveguide solutions. In the case of the segmented optical systems, by way of example, a plurality of light emitting diodes are arranged on a carrier and mirrors are assigned to the individual light emitting diodes, which mirrors deflect the light from the light emitting diodes in different spatial directions. In the case of the 3D arrangements, a plurality of light emitting diodes are fixed to three-dimensionally structured surfaces in such a way that the half-spaces into which the light emitting diodes emit their light are different. In the case of the remote phosphor concept, phosphors in a conversion element are excited to emit light with the aid of excitation radiation, wherein the emission can be effected in different spatial directions by suitable shaping of the conversion element. In the case of the optical waveguide solution, the light emitting diodes are arranged on a carrier and their light is coupled into an optical waveguide, at the end of which is arranged a scattering body that scatters the light in different spatial directions. These devices for converting a source radiation distribution into a target radiation distribution can for example be very tolerance-sensitive and/or complex, can for example require a relatively large amount of structural space or high outlay during production and/or have low efficiency.

### SUMMARY

In various embodiments a device for providing electromagnetic radiation including a predefined target radiation distribution is provided which is embodied in a simple, tolerance-insensitive and/or cost-effective fashion and/or which enables efficient conversion of a predefined source radiation distribution into the predefined target radiation distribution.

In various embodiments a method for producing a lens arrangement is provided which enables the lens arrangement to be produced in a simple and/or cost-effective manner such that efficient conversion of a predefined source radiation distribution into a predefined target radiation distribution is possible with the aid of the lens arrangement.

In various embodiments a device for providing electromagnetic radiation including a predefined target radiation distribution is provided. The device includes a radiation arrangement for generating electromagnetic radiation to be deflected including a predefined source radiation distribution and a lens arrangement for deflecting the electromagnetic radiation to be deflected. The lens arrangement has a first lens and a second lens. The first lens has a first interface and a second interface. The first interface is embodied in a concave fashion and the second interface is embodied in a convex fashion. The concave first interface forms a first cutout. The second lens has a third interface and a fourth interface. The third interface is embodied in a concave fashion and the fourth interface is embodied in a convex fashion. The concave third interface forms a second cutout, in which at least one part of the first lens is arranged. The radiation arrangement is arranged such that at least one portion of the electromagnetic radiation to be deflected enters the lens arrangement via the first interface.

The device can serve for example to generate the predefined target radiation distribution in a simple, cost-effective and/or efficient manner proceeding from the predefined source radiation distribution. The radiation arrangement can have one or more radiation sources, for example. In the case of more than one radiation source, the radiation sources can be arranged on one, two or more surfaces. Segmented optical systems can be dispensed with. The radiation sources can for example each have a first side with in each case at least one first active region for emitting the radiation to be deflected. The radiation sources may include for example one or more surface emitters, Lambertian emitters, LEDs and/or OLEDs. If the lens arrangement has a matt appearance and/or one or more roughened interfaces, then an external structure of the radiation arrangement may be masked with the aid of the lens arrangement. The device may be configured as an incandescent lamp retrofit, for example.

The lens arrangement may serve for example to generate electromagnetic radiation including the predefined target radiation distribution in a simple, cost-effective and/or efficient manner proceeding from the predefined source radiation distribution of the electromagnetic radiation of the radiation arrangement. Furthermore, the lens arrangement can be produced in a simple and/or cost-effective manner.

The source radiation distribution can be for example that of a Lambertian emitter. The target radiation distribution can be for example uniform, homogeneous and/or omnidirectional. The fact that the target radiation distribution is uniform can mean, for example, that for all source angles of the electromagnetic radiation within a predefined solid angle range the ratio of the radiance at one of the source angles to the average radiance is for example between 0.3 and 3.0, for example between 0.5 and 2.0, for example between 0.8 and 1.2. The fact that the target radiation distribution is omnidirectional means, for example, that the radiance distribution is uniform or at least substantially uniform in a large solid angle range, for example in a solid angle range of 150° to −150°, for example of 130° to −130°.

The first lens and/or the second lens can be meniscus lenses, for example. The first lens has for example a first side of the first lens and a second side of the first lens, said second side facing away from the first side of the first lens. The first interface can be embodied at the first side of the first lens and the second interface can be embodied at the second side of the first lens. The second lens has for example a first side of the second lens and a second side of the second lens, said second side facing away from the first side of the second lens. The first side of the second lens faces the first lens, for example, and the second side of the second lens faces away from the first lens, for example. The second side of the first lens can face the second lens and the first side of the first lens can face away from the second lens. The third interface is embodied at the first side of the second lens and the fourth interface is embodied at the second side of the second lens. The fourth interface may form an outer surface of the lens arrangement. If appropriate, the shape of the fourth interface contributes to the external appearance of the lens arrangement. As an alternative thereto, one, two or more further lenses having corresponding further interfaces can also be arranged. By way of example, the fourth interface can be shaped similarly to the glass bulb of a conventional incandescent lamp. This makes it possible to use the lens arrangement for an incandescent lamp retrofit. The lenses may include or be formed from glass and/or plastic.

Furthermore, for the purpose of cooling the radiation arrangement, one or both lenses can be thermally coupled to a carrier for carrying the radiation arrangement. By way of example, the corresponding lens can be coupled to a heat sink and/or a base of the radiation arrangement with physical contact. In other words, the corresponding lens can serve as a cooling element for the radiation arrangement. In this connection it can be particularly advantageous if the material of the lens has a high thermal conductivity and/or is formed from glass.

Furthermore, alternatively or additionally at least one of the interfaces can be roughened, as a result of which the radiation passing through it/them can be scattered. The roughening of the interfaces can contribute to masking and/or homogenizing a radiation distribution of the radiation. By way of example, the fourth interface can be roughened. By virtue of the roughened interface, the lens arrangement can be given a matt appearance.

The first lens can be arranged for example partly or completely in the second cutout of the second lens. The first cutout of the first lens can serve for example for partly or completely accommodating the radiation arrangement and/or one, two or more radiation sources. The radiation sources may include or be for example one, two or more light emitting semiconductor components, for example LEDs and/or OLEDs. The first interface serves for example for coupling in electromagnetic radiation to be coupled into the lens arrangement and the fourth interface serves for example for coupling out electromagnetic radiation to be coupled out from the lens arrangement. The electromagnetic radiation to be coupled in can also be designated as electromagnetic radiation to be deflected. The electromagnetic radiation to be coupled out can also be designated as emerging electromagnetic radiation. The electromagnetic radiation to be coupled in or to be deflected has the predefined source radiation distribution and the coupled-out or emerged electromagnetic radiation has the predefined target radiation distribution.

In various embodiments the first lens has a first refractive power and the second lens has a second refractive power. The interfaces are embodied for example such that the two refractive powers are equal in magnitude. By way of example, the refractive powers can be distributed uniformly among all four interfaces.

In various embodiments at least one of the interfaces has at least one step. By way of example, a surface profile of at least one of the interfaces has the step. By way of example, the second interface and the third interface each have a step, wherein the two steps can be coordinated with one another. The steps can contribute to embodying the lenses in a relatively thin fashion, which can contribute for example to the lens arrangement being light and/or requiring little structural space, and/or which can contribute to low production costs. As an alternative thereto, at least one of the interfaces can be embodied in a continuous fashion and/or at least one of the interfaces with step can otherwise be embodied in a continuous fashion.

In various embodiments at least one of the two lenses is embodied as a Fresnel lens. The Fresnel lens can have for example one or more steps at one or both of its interfaces.

In various embodiments the radiation arrangement is arranged at least partly in the first cutout. By way of example, the radiation sources and/or the active regions thereof are arranged in the first cutout. This can contribute in a simple manner, for example, to the entire electromagnetic radiation emitted and/or to be deflected by the radiation arrangement for example being coupled into the first interface and/or into the lens arrangement. By way of example, the radiation arrangement is arranged completely in the first cutout. In various embodiments, the lens arrangement is embodied such that at least one portion of the electromagnetic radiation to be deflected and/or entering the lens arrangement is refracted at each of the interfaces. By way of example, the entire electromagnetic radiation emitted by the radiation arrangement can be refracted at each of the four interfaces. This can contribute to the generation of the predefined target radiation distribution being particularly efficient.

In various embodiments the interfaces are embodied depending on the refractive indices of the lenses such that a first refraction angle of the electromagnetic radiation at the first interface, a second refraction angle of the electromagnetic radiation at the second interface, a third refraction angle of the electromagnetic radiation at the third interface and/or a fourth refraction angle of the electromagnetic radiation at the fourth interface are equal in magnitude.

In various embodiments the radiation arrangement has a first radiation source and at least one second radiation source for emitting the electromagnetic radiation to be deflected. The first and/or the second radiation source can correspond for example to one of the radiation sources explained above. The radiation arrangement in this connection can also be designated as a radiation source array, for example as an LED array, or as a light engine.

In various embodiments a method for producing a lens arrangement is provided, for example for producing the lens arrangement explained above. In the method, the source radiation distribution of the electromagnetic radiation to be deflected with the aid of the lens arrangement is predefined. Furthermore, the desired target radiation distribution of the electromagnetic radiation emerging from the lens arrangement is predefined. Depending on the predefined source radiation distribution and the predefined target radiation distribution, target angles of the emerging electromagnetic radiation are assigned to source angles of the electromagnetic radiation to be deflected. On the basis of the assignment with respect to the pairs of source angles and target angles deflection angles are determined by which the radiation to be deflected has to be deflected in order that the radiation emerging from the lens arrangement has the predefined target radiation distribution. Surface profiles of the interfaces of the lens arrangement are determined depending on the source angles and the corresponding deflection angles.

Each of the source angles represents an angle formed by one or more of the beam paths of the electromagnetic radiation to be deflected with the aid of the lens arrangement prior to entering the lens arrangement and a surface normal to the radiation arrangement and/or radiation source used and/or an axis of symmetry of the lens arrangement. Each of the target angles represents an angle formed by one or more of the beam paths of the electromagnetic radiation emerging from the lens arrangement and the surface normal to the radiation arrangement to be used and/or the axis of symmetry of the lens arrangement. The radiation distributions indicate for example the radiance distribution depending on the solid angle or the cumulated luminous flux depending on the source angles or target angles. By way of example, the cumulated luminous flux can be determined on the basis of the radiance distribution, for example by integration of the radiance distribution.

The target angles are assigned to the source angles for example such that the cumulated luminous flux present in the case of a predefined source angle is equal to the cumulated luminous flux in the case of the corresponding target angle. In other words, by way of example, the source angles can in each case be assigned the target angles for which the cumulated luminous flux is equal in magnitude to that for the corresponding source angle. The deflection angles can be determined e.g. by the subtraction of the source angles from the corresponding target angles.

For determining the surface profiles, one, two or more start points can be predefined. The start points are representative for example of intersection points between one of the beam paths of the radiation and the interfaces. The start points serve as starting points for the calculation of the surface profiles of the corresponding interfaces. In other words, the start points can constitute boundary conditions to be fulfilled when determining the surface profiles of the interfaces. Proceeding from the start points, the surface profiles can be determined for example with the aid of Snell's law of refraction.

In various embodiments first refraction angles, second refraction angles, third refraction angles and fourth refraction angles are determined depending on the source angles and the corresponding deflection angles. The surface profile of the first interface is determined depending on the first refraction angles, the surface profile of the second interface is determined depending on the second refraction angles, the surface profile of the third interface is determined depending on the third refraction angles and the surface profile of the fourth interface is determined depending on the fourth refraction angles. The first refraction angles are angles by which the electromagnetic radiation to be deflected is refracted upon entering the first lens at the first interface, the second refraction angles are angles by which the electromagnetic radiation that entered the first lens is refracted upon emerging from the first lens at the second interface, the third refraction angles are angles by which the electromagnetic radiation entering the second lens is refracted at the third interface, and the fourth refraction angles are angles by which the electromagnetic radiation emerging from the second lens is refracted at the fourth interface. The refraction angles can vary along the corresponding interface.

In various embodiments the refraction angles are predefined such that for electromagnetic radiation along one of the beam paths through the radiation arrangement the refraction angles at all interfaces are equal in magnitude. This makes it possible in a simple manner to distribute the refractive powers uniformly among all interfaces.

In various embodiments a Lambertian radiation distribution is predefined as the source radiation distribution. The Lambertian radiation distribution is for example typical of a surface emitter, such as an LED or OLED, for example.

In various embodiments a uniform radiation distribution is predefined as the target radiation distribution. By way of example, the target radiation distribution can be homogeneous or virtually homogeneous in a predefined angular range and/or the target radiation distribution can be omnidirectional or substantially omnidirectional.

In various embodiments a Fresnelization is carried out when determining the surface profiles in the case of at least one of the interfaces. The Fresnelization leads to a surface profile having one, two or more steps. The Fresnelization can contribute to being able to produce the corresponding lens in a particularly thin, light and/or cost-effective fashion. The more steps are formed at the corresponding interface, the lesser the extent to which the individual steps cast shadows. The number, height, positions and/or the steepness of the steps or Fresnel flanks can be optimized in accordance with the target radiation distribution to be achieved. The surface profile of the corresponding Fresnelized lens can be determined such that the latter has no undercut at the steps, which can contribute to a simple production process. The Fresnelized lens can be produced in an injection-molding method, for example. The Fresnelizing can contribute to a particularly uniform radiation distribution. By way of example, the Fresnelization can be carried out by two, three or more start points being predefined for an interface. The corresponding surface profile can then be calculated for example from the first to the second start point and then from the second to the third start point, wherein the step can then be formed at the second start point.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows a radiance distribution of a Lambertian emitter,

FIG. 2 shows a uniform radiance distribution,

FIG. 3 shows one embodiment of a device for providing a predefined target radiation distribution,

FIG. 4 shows a radiance distribution of the device in accordance with FIG. 3,

FIG. 5 shows one embodiment of a device for providing a predefined target radiation distribution,

FIG. 6 shows a radiance distribution of the device in accordance with FIG. 5,

FIG. 7 shows one embodiment of a device for providing a predefined target radiation distribution,

FIG. 8 shows a radiance distribution of the device in accordance with FIG. 7, and

FIG. 9 shows a flow chart of one embodiment of a method for producing a lens arrangement,

FIG. 10 shows a diagram with cumulative luminous flux as a function of a limit angle,

FIG. 11 shows a diagram with target angle profiles and a source angle profile,

FIG. 12 shows an exemplary schematic diagram and formulae concerning Snell's law of refraction,

FIG. 13 shows a diagram with exemplary surface profiles,

FIG. 14 shows a diagram with exemplary surface profiles,

FIG. 15 shows one embodiment of a device for providing a predefined target radiation distribution,

FIG. 16 shows one embodiment of a lens element, and

FIG. 17 shows one embodiment of a device for providing a predefined target radiation distribution.

### DETAILED DESCRIPTION

In the following detailed description, reference is made to the accompanying drawings, which form part of this description and show for illustration purposes specific embodiments in which the invention can be implemented. In this regard, direction terminology such as, for instance, “at the top”, “at the bottom”, “at the front”, “at the back”, “front”, “rear”, etc. is used with reference to the orientation of the figure(s) described. Since component parts of embodiments can be positioned in a number of different orientations, the direction terminology serves for illustration purposes and is not restrictive in any way at all. It goes without saying that other embodiments can be used and structural or logical changes can be made, without departing from the scope of protection of the present invention. It goes without saying that the features of the various embodiments described herein can be combined with one another, unless specifically indicated otherwise. The following detailed description should therefore not be interpreted in a restrictive sense, and the scope of protection of the present invention is defined by the appended claims.

In the context of this description, the terms “connected” and “coupled” are used to describe either a direct or an indirect connection, and a direct or indirect coupling. In the figures, identical or similar elements are provided with identical reference signs insofar as this is expedient.

In various embodiments a light emitting component can be a light emitting semiconductor component and/or be embodied as a light emitting diode (LED), an organic light emitting diode (OLED) or as an organic light emitting transistor. In various embodiments the light emitting component can be part of an integrated circuit. Furthermore, a plurality of light emitting components can be provided, for example in the manner accommodated in a common housing.

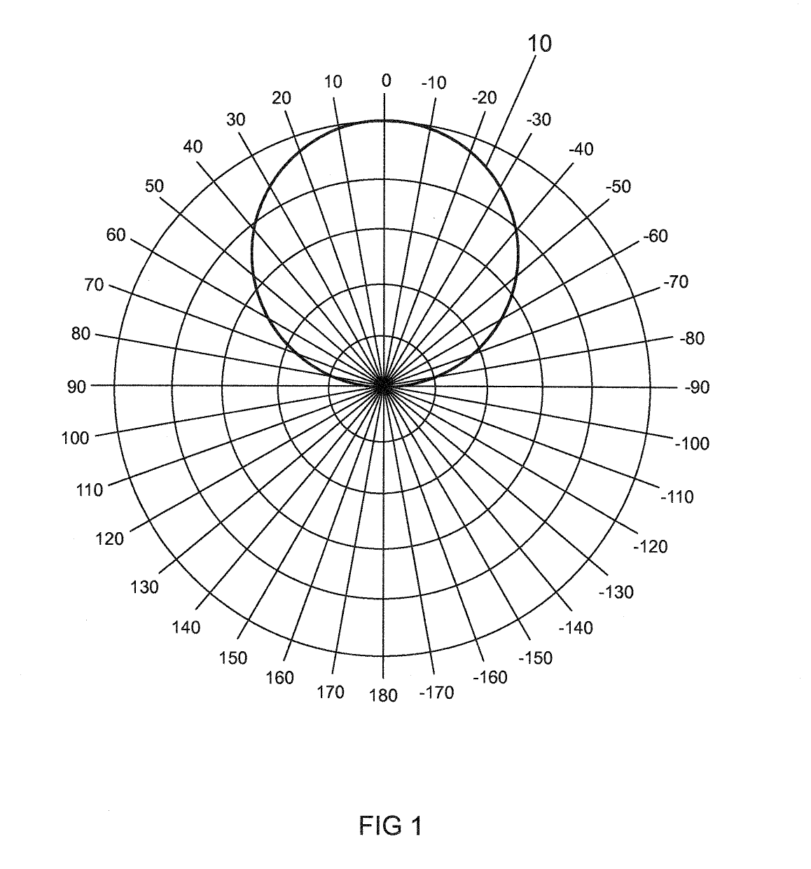

FIG. 1 shows a radiance distribution 10 of a Lambertian emitter. The Lambertian radiance distribution 10 can represent an emission characteristic of the Lambertian emitter. The Lambertian emitter is formed by a radiation source or includes the radiation source, wherein the radiation source includes at least one component which emits electromagnetic radiation. The Lambertian emitter is for example a surface emitter, for example a light emitting component, which has at least at one side a flat surface at which the radiation is emitted. The Lambertian radiance distribution 10 is plotted in a solid angle diagram extending in a solid angle range of 180° to −180°, that is to say through 360°. A surface normal to the surface of the surface emitter is parallel to the axis which extends from solid angle 0° perpendicularly to solid angle 180°. Hereinafter, the term “surface normal” exclusively denotes a straight line which is perpendicular to the surface of the surface emitter, the radiation arrangement 16 and/or the radiation source.

The Lambertian radiance distribution 10 is normalized and the radius of the solid angle diagram is representative of the percentage light intensity relative to the maximum light intensity. The Lambertian radiance distribution 10 forms a circle in a half-space which extends in the clockwise direction from 90° to −90°. The half-space is defined and/or delimited by that surface of the surface emitter which emits the electromagnetic radiation. The radiance attains its maximum at solid angle 0° and falls toward an edge of the surface emitter. That means that the entire electromagnetic radiation emitted by the Lambertian emitter is emitted into the half-space above the surface emitter, wherein the radiance is maximal along the surface normal to the surface emitter and falls toward the edge of the surface emitter.

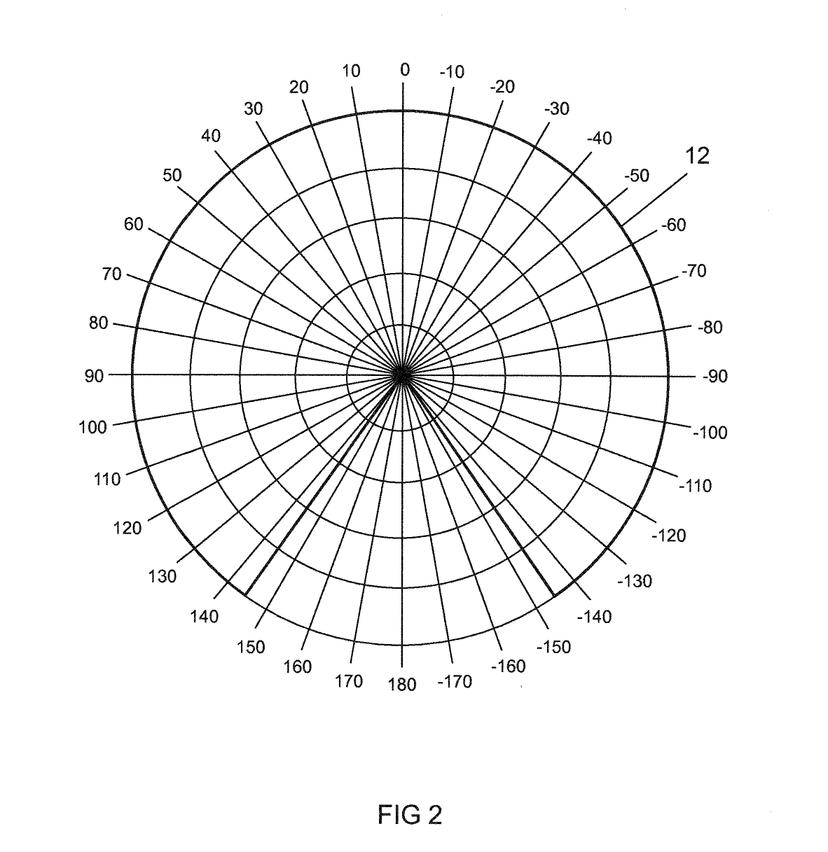

FIG. 2 shows an omnidirectional radiation distribution 12. The omnidirectional radiance distribution 12 is uniform in a large angular range, for example in the clockwise direction from 145° to −145°, and can therefore also be designated as a uniform radiance distribution. By way of example, radiation having such an or a similar omnidirectional radiance distribution 10 can be generated by a conventional incandescent lamp, wherein the solid angle range in the clockwise direction from −145° to 145° is shaded for example by the base of the incandescent lamp.

In this application, an omnidirectional radiation distribution can be understood to mean, for example, a radiation distribution in which, at all solid angles within a large solid angle range, the ratio of radiance to average radiance is in a predefined range. The solid angle range can be for example between 155° and −155°, for example between 145° and −145°, for example between 135° and −135°. At all solid angles in the large solid angle range, for example, the light intensity can fulfill the requirement that the quotient of the corresponding light intensity divided by the average light intensity in the entire large solid angle range is in a range of for example between 0.3 and 3.0, for example between 0.5 and 2.0, for example between 0.8 and 1.2.

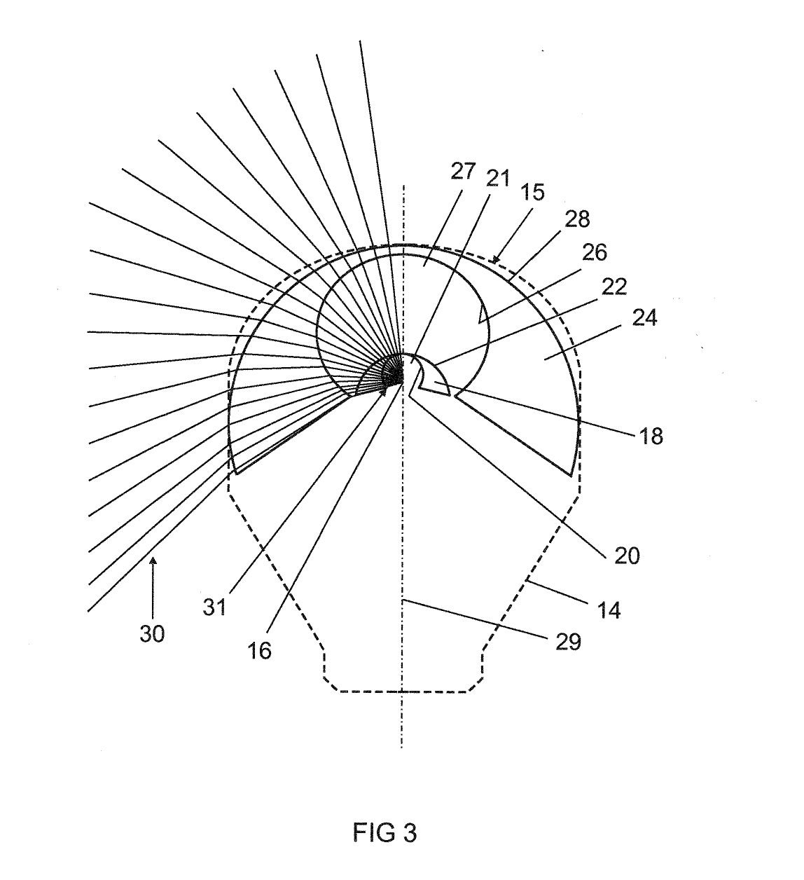

FIG. 3 shows a device 14 for providing radiation including a predefined target radiation distribution, for example a uniform and/or omnidirectional target radiation distribution 12. By way of example, with the aid of the device 14, the Lambertian radiance distribution 10 can be converted into a uniform radiance distribution which is at least similar to the omnidirectional radiance distribution 12. The radiance distribution to be converted, for example the Lambertian radiance distribution 10, can be designated as source radiation distribution and the omnidirectional radiation distribution 12 can be designated as target radiation distribution.

For providing the predefined target radiation distribution, the device 14 includes a lens arrangement 15 and a radiation arrangement 16. The radiation arrangement 16 generates electromagnetic radiation including the source radiation distribution. For generating the electromagnetic radiation, the radiation arrangement 16 has at least one radiation source, for example a surface emitter and/or a light emitting component. The radiation source can emit electromagnetic radiation of one wavelength or a plurality of wavelengths. By way of example, the radiation source can be an RGB LED module. Alternatively or additionally, a plurality of radiation sources can in each case emit electromagnetic radiation having a different wavelength and/or a plurality of radiation sources can form an RGB module and/or an LED module. Furthermore, the radiation source can have a scattering element, for example including scattering particles for scattering the electromagnetic radiation generated, and/or a conversion element for converting the wavelengths of the electromagnetic radiation generated. The radiation arrangement 16 can also have two, three or more radiation sources. Furthermore, the device 14 may include a carrier (not illustrated) for carrying the radiation arrangement 16, a heat sink (not illustrated) for dissipating heat from the radiation arrangement 16 and/or a base for making contact with and/or fixing the device 14.

The lens arrangement 15 has a first lens 18 and a second lens 24. The lens arrangement 15 can be embodied for example rotationally symmetrically with respect to an axis 29 of symmetry. As an alternative thereto, the lens arrangement 15 can also be extruded and/or the axis 29 of symmetry can be representative of a plane of symmetry with respect to which the lens arrangement 15 is mirror-symmetrical, for example, wherein the shown profile of the lens arrangement 15 in a direction perpendicular to the axis 29 of symmetry and/or the plane of the drawing can then be identical to the shown profile (see FIG. 17). The first lens 18 has a first side facing the radiation arrangement 16 and a second side facing away from the radiation arrangement 16 and facing the second lens 24. The two lenses 18, 24 can be embodied as meniscus lenses, for example.

A first interface 20 is embodied at the first side of the first lens 18. A second interface 22 is embodied at the second side of the first lens 18. The first side of the first lens 18 and the first interface 20 are embodied in a concave fashion and the second side of the first lens 18 and the second interface 22 are embodied in a convex fashion. A first cutout 21 is formed by the concave first side of the first lens 18 or by the first interface 20, at least one part of the radiation arrangement 16 being arranged in said first cutout. By way of example, a side and/or surface of the radiation arrangement 16 which emits the electromagnetic radiation is arranged in the first cutout. By way of example, the radiation arrangement 16 is arranged completely in the first cutout 21.

The second lens 24 has a first side facing the first lens 18 and a second side facing away from the first lens 18. A third interface 26 is embodied at the first side of the second lens 24 and a fourth interface 28 is embodied at the second side of the second lens 24. The first side of the second lens 24 and the third interface 26 are embodied in a concave fashion and form a second cutout 27. The second side of the second lens 24 is embodied in a convex fashion. The first lens 18 is arranged at least partly in the second cutout 27 of the second lens 24. By way of example, the first lens 18 is arranged completely in the second cutout 27 of the second lens 24.

The radiation arrangement 16 generates electromagnetic radiation 31 to be deflected with the aid of the lens arrangement 15 and emits the electromagnetic radiation 31 to be deflected into the half-space lying above the radiation arrangement 16 in FIG. 3. In this embodiment it is assumed here that the radiation source of the radiation arrangement 16 is approximately a point radiation source. The electromagnetic radiation 31 to be deflected enters the first lens 18 and thus the lens arrangement 15 at the first interface 20. The electromagnetic radiation that has entered the lens arrangement 15 can also be designated as coupled-in radiation. The radiation that has entered the lens arrangement 15 is refracted successively at the first interface 20, at the second interface 22, at the third interface 26 and at the fourth interface 28. The radiation that has entered the lens arrangement 15 emerges from the lens arrangement 15 at the fourth interface 28 and can then be designated as emerged electromagnetic radiation 30. The electromagnetic radiation 31 to be deflected is thus refracted four times with the aid of the lens arrangement and then emerges from the lens arrangement 15 as deflected, emerging electromagnetic radiation 30. The electromagnetic radiation 31 that is emitted and/or to be deflected can be for example light in the visible range and/or UV light or infrared light.

The device 14 can be embodied for example as an incandescent lamp retrofit. By way of example, the second side of the second lens 24 and/or the fourth interface 28 can be shaped and/or embodied in a manner corresponding to a conventional incandescent lamp, such that the lens arrangement 15 gives the device 14 the external appearance of an incandescent lamp. As an alternative thereto, the device 14 may include an outer body (indicated by dashed lines in FIG. 3), for example a glass bulb, which is embodied in a manner corresponding to a conventional incandescent lamp.

The first lens 18 and/or the second lens 24 may include or be formed from glass and/or plastic. Furthermore, the first and/or the second lens 18, 24 can be thermally coupled to the carrier, the base and/or the heat sink of the device 14. The thermal coupling can be effected via direct physical contact, for example, such that heat which arises during the operation of the radiation arrangement 16 can be dissipated via the corresponding lens 18, 24. In other words, the first and/or the second lens 18, 24 can serve as a cooling element and/or heat sink for the radiation arrangement 16. In this connection it is particularly advantageous if the corresponding lens 18, includes material having a particularly high thermal conductivity coefficient, for example glass. Alternatively or additionally, one, two or more of the interfaces 20, 22, 26, 28 can be embodied for example in a scattering and/or matt fashion. The radiation 31 to be deflected can be scattered as a result. This can contribute to the emerged electromagnetic radiation 30 having a blurred, homogenized and/or uniform target radiation distribution and/or structures of the radiation arrangement 16, for example of the radiation sources, being masked.

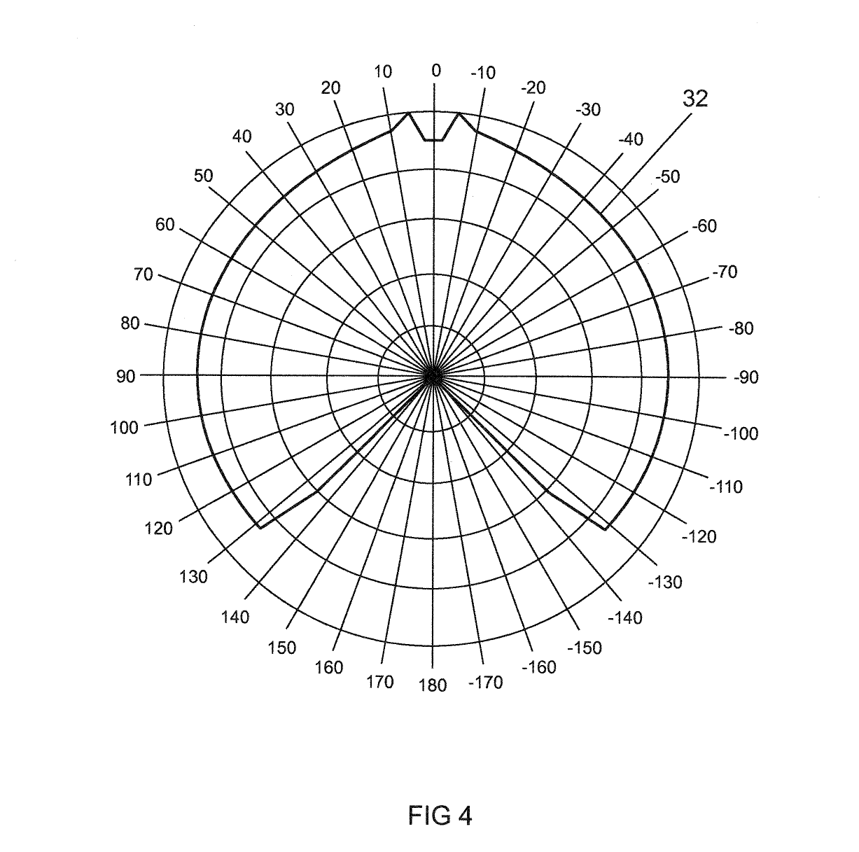

FIG. 4 shows a first radiance distribution 32 of the coupled-out radiation 32, which corresponds to the target radiation distribution of the radiation 30 coupled out from the device 14 in accordance with FIG. 3. It is clear from FIG. 4 that the first radiance distribution 32 is substantially uniform in a large angular range, for example between 130° and −130°.

The first radiance distribution 32 can thus be designated as a uniform and/or omnidirectional radiance distribution. Furthermore, the first radiance distribution 32 corresponds to the predefined target radiation distribution, for which reason the device 14 in accordance with FIG. 3 is suitable for providing electromagnetic radiation including the predefined target radiation distribution.

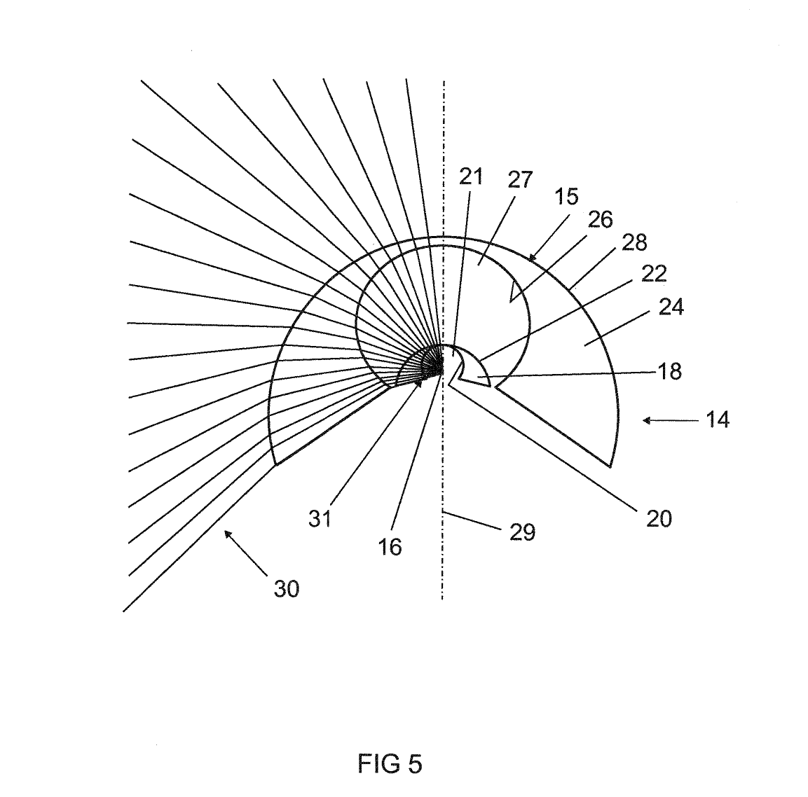

FIG. 5 shows one embodiment of the device 14 including the lens arrangement 15 and the radiation arrangement 16, which embodiment largely corresponds to the embodiment shown in FIG. 3, wherein in contrast thereto, in the case of the embodiment shown in FIG. 5, the radiation arrangement 16 does not have a point radiation source, but rather an areally extended radiation source. By way of example, the radiation arrangement 16 in accordance with FIG. 5 can have an extended surface emitter and/or for example one, two or more radiation sources, for example light emitting components. In this embodiment, too, the source radiation distribution of the radiation 31 to be deflected is converted into electromagnetic radiation, namely into emerging electromagnetic radiation 30, including the predefined target radiation distribution with the aid of the radiation arrangement 16.

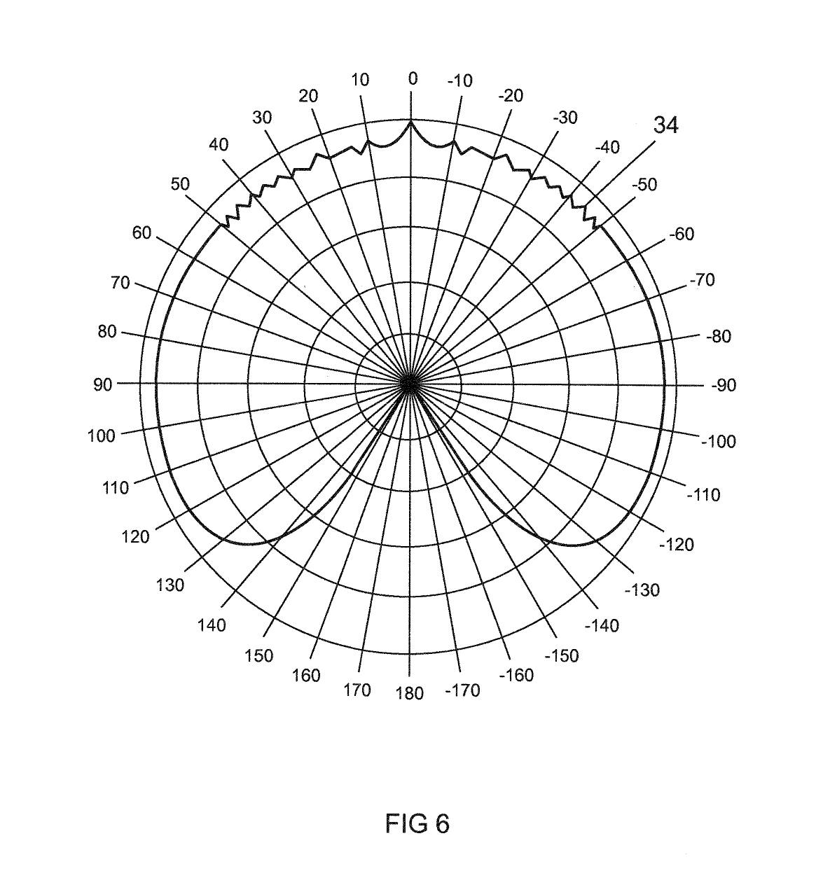

FIG. 6 shows a second radiance distribution 34 of the emerging electromagnetic radiation 30, which corresponds to the target radiation distribution of the device 14 in accordance with FIG. 5. The second radiance distribution 34 is uniform or at least substantially uniform in a large angular range, for example from 130° to −130°, and can therefore also be designated as a uniform and/or omnidirectional radiance distribution. Consequently, the device 14 shown in FIG. 5 is also suitable for providing electromagnetic radiation including the predefined target radiation distribution.

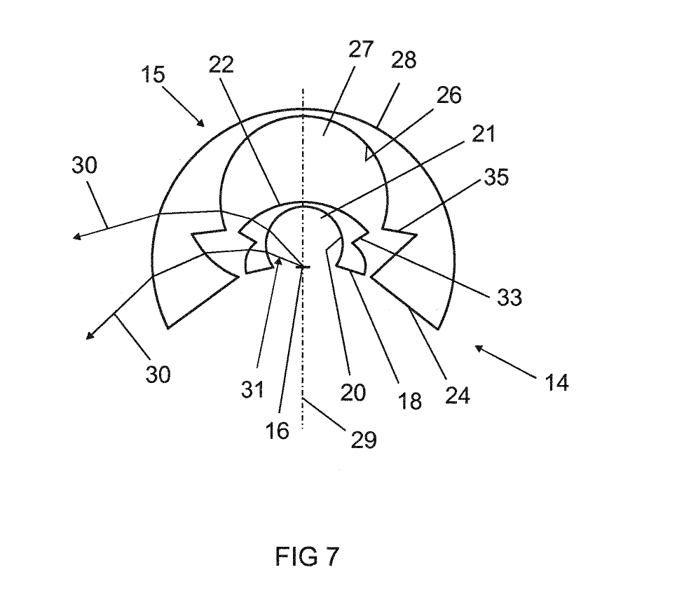

FIG. 7 shows one embodiment of the device 14, which embodiment largely corresponds to the embodiment of the device 14 as shown in FIG. 3, wherein in contrast thereto, in the case of the embodiment shown in FIG. 7, the lens arrangement 15 has a first step 33 at the second interface 22 and a second step 35 at the third interface 26. Alternatively or additionally, the first interface 20 and/or the fourth interface 28 can also have a step or one, two or more of the interfaces 20, 22, 26, can each have two or more steps. In this connection the first and/or the second lens 18, 24 can also be designated as Fresnel lenses. The formation of the first and/or second step 33, 35 can also be designated as Fresnelizing the corresponding lens 18, 24. The Fresnelized lenses 18, 24 are embodied in a thinner and correspondingly lighter fashion compared with lenses which are not Fresnelized but generate the same, or largely the same, target radiation distribution for a given source radiation distribution. The steps 33, 35 are embodied for example such that they have no undercut in the material of the corresponding lens 18, 24.

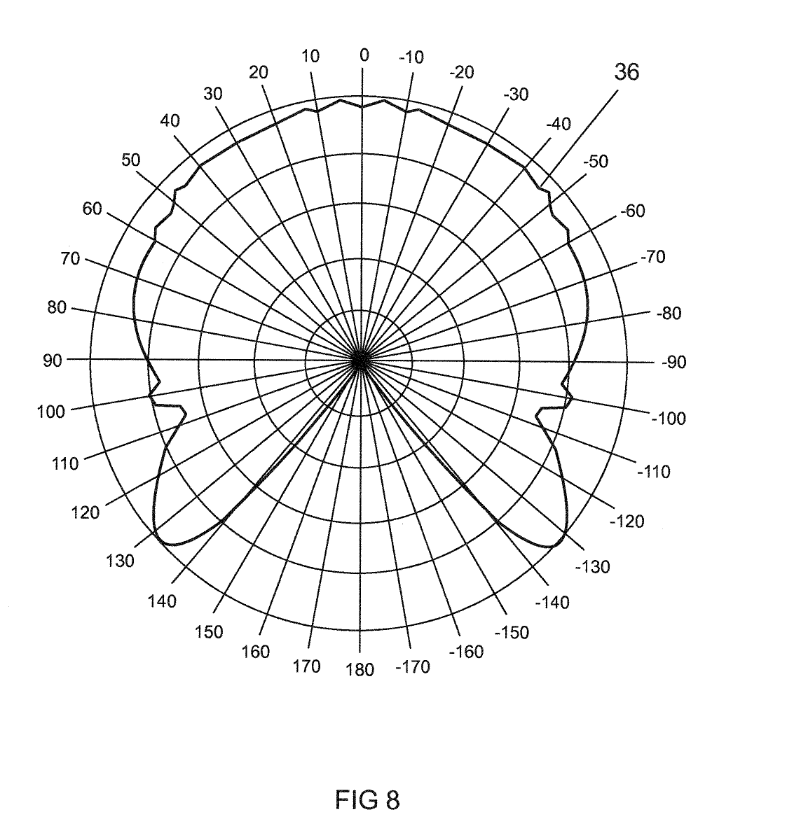

FIG. 8 shows a third radiance distribution 36, which corresponds to the target radiation distribution of the device in accordance with FIG. 7. The third radiance distribution is uniform or at least substantially uniform in a large angular range and can therefore be designated as a uniform and/or omnidirectional radiance distribution.

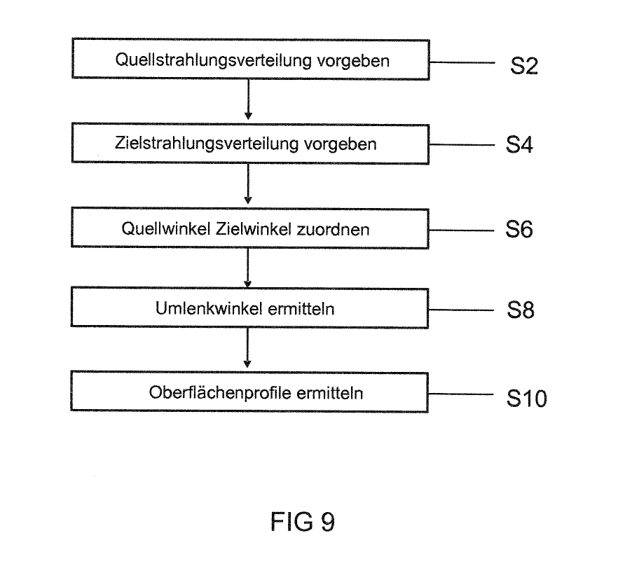

FIG. 9 shows a flow chart of one embodiment of a method for producing a lens arrangement, for example the lens arrangement explained above. The method serves, depending on the predefined source radiation distribution, for example the Lambertian radiance distribution 10, to embody the lens arrangement 15 such that with the aid thereof the predefined target radiation distribution, for example the omnidirectional target radiation distribution 12 and/or the first, second or third target radiation distribution 32, 34, 36, can be generated. In this embodiment of the method it is assumed that the emissive area of the radiation arrangement 16 is small compared with the lens arrangement 15, for example smaller by a factor of 10 or more, for example so small that the diameter of the area of the radiation arrangement 16 which emits the electromagnetic radiation can be disregarded for calculation. By way of example, the radiation source of the radiation arrangement 16 can be assumed to be a point radiation source (see FIG. 3). As an alternative thereto, an areally extended radiation source can also be assumed (see FIG. 5).

In a step S2, the source radiation distribution is predefined. By way of example, the source radiation distribution is predefined depending on the radiation arrangement 16 used. By way of example, the source radiation distribution can be determined empirically by measurement of the radiance distribution of the electromagnetic radiation emitted by the radiation arrangement 16 and can then be predefined for producing the lens arrangement 15. As an alternative thereto, the Lambertian radiation distribution 10 can be predefined as the source radiation distribution.

In a step S4, the target radiation distribution is predefined, for example the omnidirectional radiation distribution 12 and/or the first, second or third target radiation distribution 32, 34, 36. The target radiation distribution can be predefined for example in accordance with a scale to be complied with, in accordance with a legal specification and/or in accordance with design concepts of a luminaire designer.

The source radiation distribution and/or the target radiation distribution can be predefined as a radiance distribution, as shown for example in FIGS. 1, 2, 4, 6 and 8. As an alternative thereto, the source radiation distribution and/or the target radiation distribution can be predefined as a cumulative energy distribution and/or as a cumulative luminous flux. The cumulative energy distribution and/or the cumulative luminous flux can be determined for example depending on the corresponding radiance distribution. In particular, the cumulative luminous flux can be determined by integration of the radiance distribution from a first limit angle to a second limit angle.

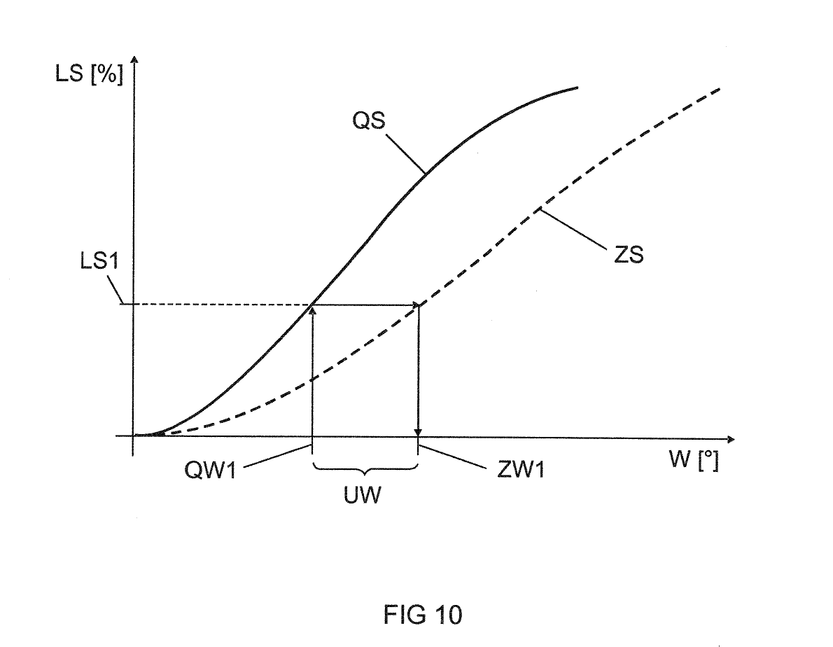

FIG. 10 shows for example a diagram in which the percentage cumulative luminous flux LS of a radiation source is indicated as a function of a limit angle W of the emitted radiation. In FIG. 10 the limit angle W runs for example from solid angle 0° to solid angle 145°. By way of example, a source luminous flux profile QS corresponding for example to that of a Lambertian emitter, for example to that of the radiation source 16, is plotted in the diagram. The source luminous flux profile QS can be determined for example by integration of the Lambertian radiation distribution 10 from solid angle 0° to solid angle 90°. The source luminous flux profile QS is illustrated as a solid line in FIG. 10. The emitted radiation is for example the radiation 31 to be deflected.

The cumulative luminous flux LS and thus the source luminous flux profile QS are dependent on the limit angle W of the emitted radiation, wherein the limit angle W corresponds to a source angle between a selected beam path of the radiation and a vertical axis of a global coordinate system, wherein the vertical axis can be for example parallel to the surface normal to the surface of the radiation source. The cumulative luminous flux LS has a first luminous flux value LS1 at a first source angle QW1 predefined by way of example. In the case of a predefined target luminous flux profile ZS, the same first luminous flux value LS1 is attained at a first target angle ZW1, which differs from the first source angle QW by a deflection angle UW. The deflection angle UW varies depending on the source angle and the target angle. By way of example, that proportion of the electromagnetic radiation to be deflected whose beam path forms the first source angle QW1 with the surface normal has to be deflected away from the surface normal by the deflection angle UW, such that the beam path of the corresponding deflected electromagnetic radiation forms the first target angle ZW1 with the surface normal. For electromagnetic radiation whose beam path forms a different source angle with the surface normal, a different deflection angle can then be determined. If such a deflection of the electromagnetic radiation is effected for all beam paths of the electromagnetic radiation 31 to be deflected, then electromagnetic radiation having the target luminous flux profile ZS can be generated with the aid of the radiation arrangement 16. The target luminous flux profile ZS is then representative of the predefined target radiation distribution.

In a step S8, the deflection angles UW are determined. By way of example, this can involve firstly carrying out a pairwise assignment of the target angles ZW to the source angles QW at which the same cumulative luminous flux LS is respectively present. The deflection angles UW can then be determined simply by subtraction of the source angles QW from the corresponding target angles ZW. Relative to the radiation arrangement 16, the deflection of the radiation 31 to be coupled in is achieved by refraction of the radiation 31 to be coupled in at the four interfaces 20, 22, 26, 28.

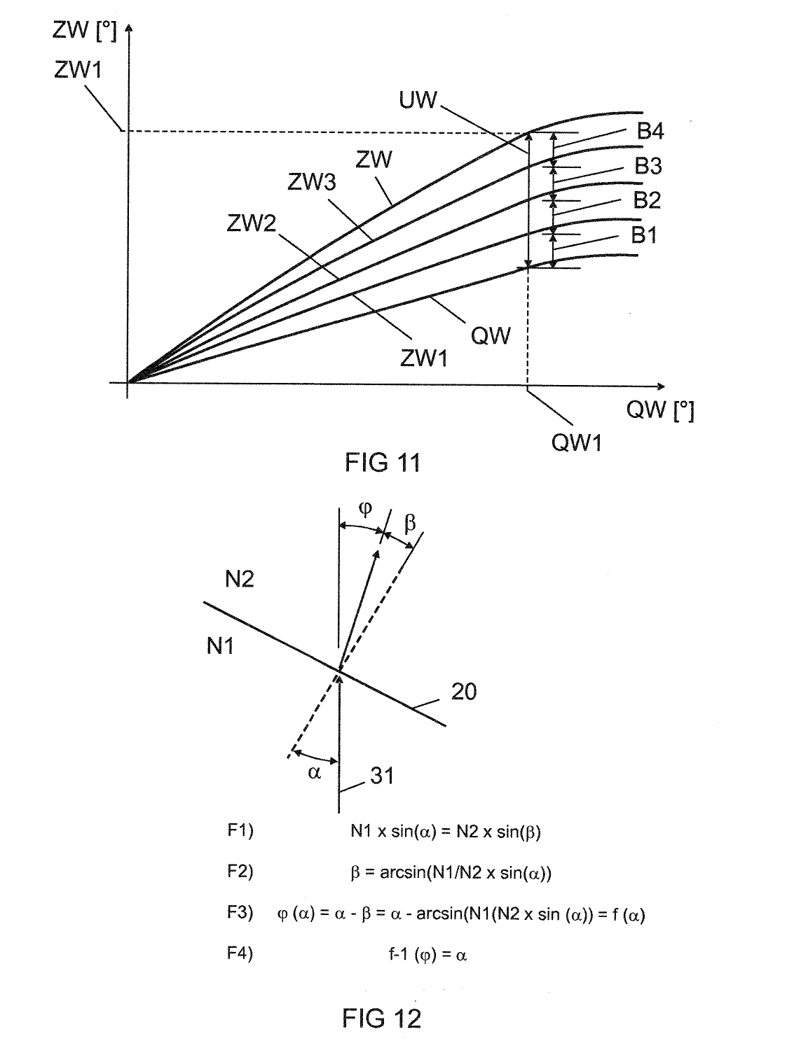

FIG. 11 shows a diagram in which a target angle profile ZW is plotted as a function of the corresponding source angles, wherein a source angle profile QW that is representative of the corresponding source angles is also plotted in the diagram. Moreover, a first target angle profile ZW1, a second target angle profile ZW2 and a third target angle profile ZW3 are plotted between the source angle profile QW and the target angle profile ZW.

Each beam path of the radiation 31 to be deflected with the aid of the lens arrangement 15, which beam path forms a first source angle QW1 with the surface normal to the radiation source, forms a target angle after entering the first lens 18 on account of the refraction at the first interface 20 by a first refraction angle B1, which target angle is assigned to the first source angle QW1 by way of the first target angle profile ZW1. The beam paths which form the first source angle QW1 with the surface normal to the radiation source before entering the first lens 18 form a target angle with the surface normal to the radiation source after emerging from the first lens 18 on account of the refraction at the second interface 22 by a second refraction angle B2, which target angle is assigned to the first source angle QW1 by way of the second target angle profile ZW2. The beam paths which form the first source angle QW1 with the surface normal to the radiation source before entering the first lens 18 form a target angle with the surface normal to the radiation source after refraction at the third interface 26 by a third refraction angle B3, which target angle is assigned to the first source angle QW1 by way of the third target angle profile ZW3. The beam paths which form the first source angle QW1 with the surface normal to the radiation source before entering the first lens 18 form a first target angle ZW1 with the surface normal after refraction at the fourth interface 28 by a fourth refraction angle B4, which first target angle is assigned to the first source angle QW1 by way of the target angle profile ZW. Consequently, the beam paths of that proportion of the electromagnetic radiation 30 emerging from the lens arrangement 15 whose beam paths form the first source angle QW1 with the surface normal to the radiation source before entering the first lens 18 form the first target angle ZW1 with the surface normal to the radiation source upon emerging from the lens arrangement 15.

The first, second, third and fourth refraction angles B1, B2, B3, B4 in relation to a respective one of the source angles sum to the deflection angle UW corresponding to the source angle. By way of example, the sum of the first refraction angle B1, the second refraction angle B2, the third refraction angle B3 and the fourth refraction angle B4 along the beam path of the radiation coupled in with the first source angle QW1 results in the deflection angle UW assigned to the first source angle QW1. The deflection angle UW represents the difference between or the difference of source angle and target angle.

In the case of the embodiment shown in FIG. 11, the refractive powers of the interfaces 20, 22, 26, 28 are distributed uniformly among all four interfaces 20, 22, 26, 28. In other words, the four refraction angles B1, B2, B3, B4 are equal in magnitude. Consequently, the refractive powers of the first and second lenses 18, 24 are also equal in magnitude. In alternative embodiments, however, the refractive powers can also be distributed non-uniformly; by way of example, the predefinition of a specific external appearance can predefine a boundary condition for the fourth interface 28 on account of which a uniform distribution of the refractive powers is not possible or is not expedient.

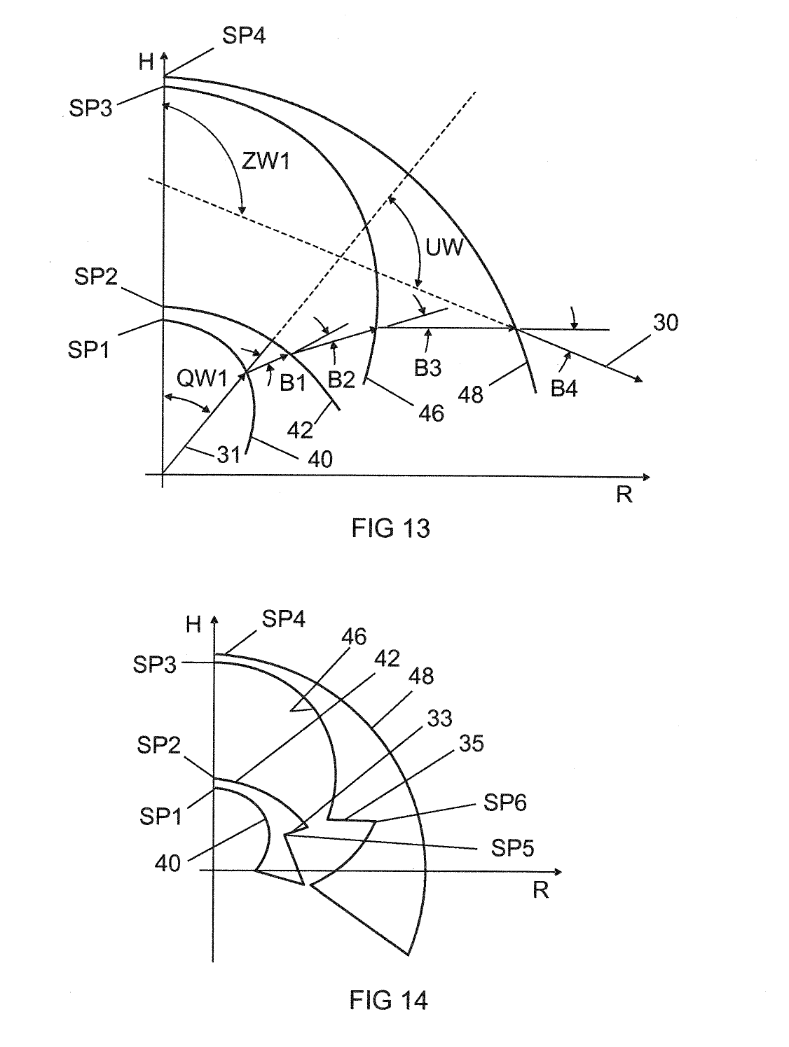

In a step S10, the surface profiles 40, 42, 46, 48 of the interfaces 20, 22, 26, 28 as shown in FIG. 13 and/or FIG. 14 are determined, for example with the aid of Snell's laws of refraction shown in FIG. 12.

In this case, FIG. 12 shows for example one of the beam paths of the electromagnetic radiation 31 to be deflected, how it is refracted at the first interface 20 and how the inclination angle of the first interface 20 relative to the beam path can be determined depending on the beam path of the electromagnetic radiation 31 to be deflected in the case of a predefined first refraction angle B1.

The space between the first interface 20 and the radiation arrangement 16 is filled for example with air and/or a protective gas and/or has a reduced pressure relative to surroundings of the device 14 and a first refractive index N1. The material of the first lens 18 has a second refractive index N2, for example. The exemplary beam path of the radiation 31 to be deflected forms an entrance angle α with a normal to the first interface 20. The normal to the first interface in principle does not correspond to the surface normal to the radiation source, wherein the normal and the surface normal can be parallel in exceptional cases, for example if the beam path of the radiation 31 to be coupled in forms the source angle 0° with the surface normal. In this application, the term “normal” is used for a straight line which, at a point of intersection of a beam path with one of the interfaces 20, 22, 26, 28 is perpendicular to the corresponding interface 20, 22, 26, 28. The radiation 31 to be deflected is refracted at the first interface 20 toward the normal to the first interface by a refraction angle φ. After refraction, the beam path of the electromagnetic radiation that has entered the first lens 18 forms an angle β with the normal to the first interface 20. In this embodiment, the refraction angle φ corresponds to the first refraction angle B1. Upon refraction at the second, third and fourth interfaces 22, 26, 28, the refraction angle φ corresponds to the second, third and fourth refraction angles B2, B3, B4, respectively. If the beam path of the electromagnetic radiation 31 to be deflected is known, then the source angle QW which the beam path forms with the surface normal to the radiation arrangement 16 is also known. With a known source angle QW, the entrance angle α is thus representative of the inclination angle of the interface 20, 22, 26, 28 relative to the surface normal to the radiation arrangement 16 at the point of intersection of the corresponding beam path with the corresponding interface 20, 22, 26, 28.

A first formula F1 shows the physical relationship known as Snell's law of refraction, which can be gathered from the graphical illustration. A second formula F2 corresponds to a solution of the first formula F1 with respect to the angle β. A third formula F3 shows the dependence of the refraction angle φ on the entrance angle α with the aid of the first formula F1 and the second formula F2. The third formula F3 reveals that the refraction angle φ is dependent only on α. In other words, there is a unique relationship between Φ and α. A formula F4 shows an inverse function of the function from the third formula F3. The inverse function yields the angle α as a function of φ. Consequently, with a predetermined beam path and thus known source angle and known refraction angle φ, it is possible to determine the inclination of the interface 20, 22, 26, 28 at the point of intersection of the corresponding beam path with the corresponding interface 20, 22, 26, 28. By way of example, it is possible to determine the inclination of the first interface 20 at the point of intersection of the beam path of the radiation 31 to be coupled in with the first interface 20 with a predefined beam path and therefore known source angle QW depending on the refraction angle φ, for example the first refraction angle B1.

Consequently, the corresponding source angle can be determined for each beam path of the electromagnetic radiation 31 to be deflected. Depending on the source angle, the deflection angle UW and for example the first refraction angle B1 can then be determined. Depending on the first refraction angle B1, it is then possible to determine the inclination angle of the first interface 20 at the point of intersection of the corresponding beam path with the first interface 20. The inclination angles of the second, third and fourth interfaces 22, 26, 28 can be determined accordingly. In this case, the inclination angles of the second interface 22 are determined depending on the beam paths of the electromagnetic radiation refracted at the first interface 20 and the second refraction angles B2, the inclination angles of the third interface 26 are determined depending on the beam paths of the electromagnetic radiation refracted at the second interface 22 and the third refraction angles B3, and the inclination angles of the fourth interface are determined depending on the beam paths of the electromagnetic radiation refracted at the third interface 28 and the fourth refraction angles B4.

FIG. 13 shows a diagram in which a radius R of the lenses 18, 24 is plotted on the horizontal axis and in which the height H of the lenses 18, 24 is plotted on the vertical axis and in which embodiments of a first surface profile 40 of the first interface 20, of a second surface profile 42 of the second interface 22, of a third surface profile 46 of the third interface 26 and of a fourth surface profile 48 of the fourth interface 28 are plotted. The surface normal is parallel to the vertical axis.

By way of example, the calculation of the first surface profile 40 can be started. Since the points of intersection of the beam paths with the interfaces 20, 22, 26, 28 are relevant for the calculation, start points of the calculation can be predefined, wherein the start points are for example representative of points of intersection of a selected beam path with the interfaces 20, 22, 26, 28. By way of example, a first start point SP1 on the Y-axis is chosen as start point for the calculation of the first surface profile 40 of the first interface 20, wherein for example a beam path of the electromagnetic radiation 31 to be deflected lies on the Y-axis, which beam path forms the source angle 0° with the surface normal. Proceeding from the first start point SP1, the first refraction angles B1 are determined on the basis of the source angles and the inclination angles of the first interface 20 are determined on the basis of the first refraction angles B1, thereby giving rise to the first surface profile 40. After the first surface profile 40 has been determined, for example a second start point SP2 can be predefined and the determination of the second surface profile 42 can be carried out proceeding from the second start point SP2 in a manner corresponding to the determination of the first surface profile 40 using the second refraction angles B2. After the second surface profile 42 has been determined, for example a third start point SP3 can be predefined and, proceeding from the third start point SP3, the determination of the third surface profile 46 can be carried out in a manner corresponding to the determination of the first surface profile 40 using the third refraction angles B3. After the third surface profile 46 has been determined, a fourth start point SP4 can be predefined and, proceeding from the fourth start point SP4, the determination of the fourth surface profile 48 can be carried out in a manner corresponding to the determination of the first surface profile 20 using the fourth refraction angles B4.

By way of example, the electromagnetic radiation 31 to be deflected, with the first source angle QW1, is refracted by the first refraction angle B1 at the first interface 20 in a manner corresponding to the first surface profile 40. The electromagnetic radiation refracted at the first interface 20 is refracted by the second refraction angle B2 at the second interface 22 in a manner corresponding to the second surface profile 42. The electromagnetic radiation refracted at the second interface 22 is refracted by the third refraction angle B3 at the third interface 26 in accordance with the third surface profile 46. The electromagnetic radiation refracted at the third interface 26 is refracted by the fourth refraction angle B4 at the fourth interface 28 in accordance with the fourth surface profile 48, such that the emerged electromagnetic radiation 30 was refracted toward the first target angle ZW1 by the deflection angle UW relative to the electromagnetic radiation to be deflected.

Since these refraction processes take place along all the beam paths of the electromagnetic radiation 31 to be deflected, the emerged electromagnetic radiation 30 has the predefined target radiation distribution.

After the surface profiles 40, 42, 46, 48 have been determined, the lenses 18, 24 can be produced, for example in an injection-molding method or by other known methods for forming optical lenses.

FIG. 14 shows the determined surface profiles 40, 42, 46, 48 in the case of Fresnelized lenses, for example corresponding to the Fresnelized lenses 18 and 24 shown in FIG. 7. In contrast to the determination of the surface profiles 40, 42, 46, 48 in accordance with FIG. 13, in the case of the surface profiles 40, 42, 46, 48 in accordance with FIG. 14, a fifth start point SP5 was predefined in the calculation of the second surface profile 42 and a sixth start point SP6 was predefined in the determination of the third surface profile 46. The determination of the second surface profile 42 is then carried out proceeding from the second start point SP2 and upon attainment of the beam path with the fifth start point SP5 is started anew proceeding from the fifth start point SP5. The determination of the third surface profile 46 is carried out proceeding from the third start point SP3 and upon intersection of the beam path with the sixth start point SP6 is started anew proceeding from the sixth start point SP6. The first and second steps 33, 35 arise as a result of the predefinition of the fifth and sixth start points SP5, SP6, respectively. The steps 33, 35 can be predefined for example such that the beam paths of the electromagnetic radiation to be deflected, proceeding from the corresponding interfaces 22, 26, run parallel to the incisions into the material of the corresponding lens 18, 24. Furthermore, the stepped surface profiles 46, 48 can be determined such that they have no undercut. This can contribute to simple production of the corresponding lenses 18, 24, for example in an injection-molding method.

If the predefined target radiation distribution cannot be obtained as desired with the aid of the lens arrangement 15 produced in accordance with the method explained above, then the surface profiles and/or the interfaces of the lenses 18, can be adapted iteratively, for example. Deviations from the desired target radiation distribution may be, for example, deviations from the desired omnidirectionality and/or from the desired uniformity. The deviations can occur for example on account of Fresnel reflections at the surfaces of the lenses 18, 24, on account of shadows passed at Fresnel edges, on account of the actual areal extent of the radiation arrangement 16 or of the radiation source and/or on account of other factors not taken into account originally. The iterative adaptation includes for example iterative compensation of the deviations. By way of example, the target radiation distribution actually obtained with the aid of a first lens arrangement can be determined and, depending on the target radiation distribution actually obtained, it is then possible to predefine a new target radiation distribution, in which the deviations are taken into account, for producing a second lens arrangement. The actual target radiation distribution of the second lens arrangement can then be nearer to the actually desired target radiation distribution originally predefined.

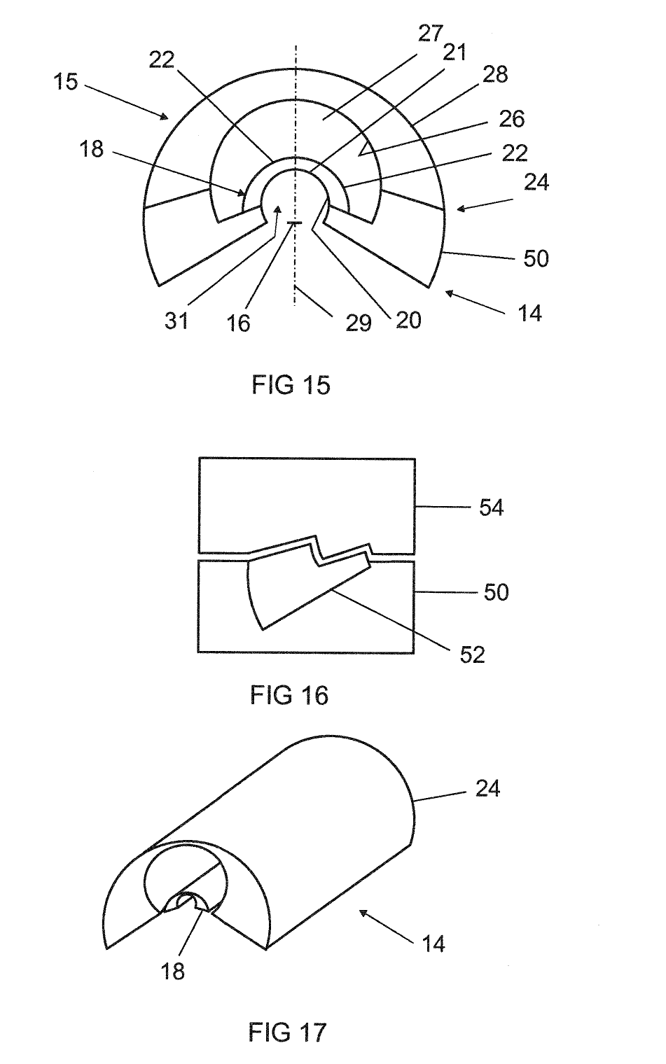

FIG. 15 shows one embodiment of the lens arrangement 15, which embodiment largely corresponds to the embodiment shown in FIG. 3, wherein in contrast thereto, in the case of the embodiment shown in FIG. 15, the first and second lenses 18, 24 consist of a total of three parts, for example, wherein one lens element 50 is part of the first lens 18 and part of the second lens 24. As an alternative thereto, the lenses 18, 24 can be formed from further lens elements.

FIG. 16 shows the lens element 50, in particular a part of the lens element 50, in a mold for producing the lens element 50. The mold has a first mold body 52 and a second mold body 54. FIG. 16 reveals, in particular, that the lens element 50 can be produced without an undercut in a simple manner. The provision of the lens element 50 can also contribute to simple production of the lenses 18, 24. By way of example, the lenses 18, 24 can also be produced without an undercut.

FIG. 17 shows one embodiment of the lens arrangement 15, which embodiment largely corresponds to the embodiment shown in FIG. 3, wherein in contrast thereto, in the case of the embodiment shown in FIG. 17, the lens arrangement 15 is elongated and/or is produced by extrusion, for example.

The present disclosure is not restricted to the embodiments indicated. By way of example, it is also possible to arrange more than two lenses 18, 24, for example a third, a fourth and/or further lenses. The number of interfaces at which the radiation to be deflected is refracted accordingly increases in each case by two. When determining the surface profiles 40, 42, 46, 48, additional boundary parameters can also be specified. By way of example, the lenses 18, 24 can be embodied in an integral fashion. As an alternative thereto, each individual one of the lenses 18, 24 can be embodied in a multipartite fashion. By way of example, the fourth interface 28 and/or the corresponding second side of the second lens 24 can be predefined in accordance with a predefined external appearance. Alternatively or additionally, the first and/or the fourth interface 20, 28 can also have one, two or more steps. Furthermore, the second and/or the third interface 22, 26 can also have one, two or more further steps. Furthermore, the radiation arrangement 16 can be connected to a heat sink and/or a base (not illustrated). The lens arrangement 15 and/or the device 14 can form a lamp and/or luminaire and/or be arranged in a lamp and/or luminaire.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. A device for providing electromagnetic radiation comprising a predefined target radiation distribution, comprising
a lens arrangement, wherein the lens arrangement has a first lens having a first interface and a second interface, wherein the first interface is embodied in a concave fashion and the second interface is embodied in a convex fashion and wherein the concave first interface forms a first cutout, and wherein the lens arrangement has a second lens having a third interface and a fourth interface, wherein the third interface is embodied in a concave fashion and the fourth interface is embodied in a convex fashion and wherein the concave third interface forms a second cutout, in which at least one part of the first lens is arranged, and
a radiation arrangement for generating electromagnetic radiation to be deflected comprising a predefined source radiation distribution, wherein the radiation arrangement is arranged such that at least one portion of the electromagnetic radiation to be deflected enters the lens arrangement via the first interface.

2. The device as claimed in claim 1, wherein the predefined target radiation distribution is uniform.

3. The device as claimed in claim 1, wherein the first lens has a first refractive power and the second lens has a second refractive power and wherein the interfaces are embodied such that the refractive powers are equal in magnitude.

4. The device as claimed in claim 1, wherein at least one of the interfaces has at least one step.

5. The device as claimed in claim 4, wherein at least one of the two lenses is embodied as a Fresnel lens.

6. The device as claimed in claim 5, wherein the radiation arrangement is arranged at least partly in the first cutout.

7. The device as claimed in claim 1, wherein the lens arrangement is embodied such that at least one portion of the electromagnetic radiation to be deflected is refracted at each of the interfaces.

8. The device as claimed in claim 7, wherein the interfaces are embodied depending on the refractive index of the material of the lenses such that a first refraction angle of entered electromagnetic radiation at the first interface, a second refraction angle of the entered electromagnetic radiation at the second interface, a third refraction angle of the entered electromagnetic radiation at the third interface and/or a fourth refraction angle of emerged electromagnetic radiation at the fourth interface are equal in magnitude.

9. The device as claimed in claim 7, wherein the radiation arrangement has a first radiation source and at least one second radiation source for generating the electromagnetic radiation to be deflected.

10. A method for producing a lens arrangement, wherein
a source radiation distribution of radiation to be deflected with the aid of the lens arrangement is predefined,
a target radiation distribution of electromagnetic radiation emerging from the lens arrangement is predefined,
depending on the predefined source radiation distribution and the predefined target radiation distribution, target angles of the emerging electromagnetic radiation are assigned to source angles of the electromagnetic radiation to be deflected,
on the basis of the assignment with respect to the pairs of source angles and target angles deflection angles are determined by which the electromagnetic radiation to be deflected has to be deflected in order that the emerged electromagnetic radiation has the predefined target radiation distribution, and
surface profiles of the interfaces of the lens arrangement are determined depending on the source angles and the corresponding deflection angles.

11. The method as claimed in claim 10, wherein a uniform radiation distribution is predefined as the target radiation distribution.

12. The method as claimed in claim 10, wherein first refraction angles, second refraction angles, third refraction angles and fourth refraction angles are determined depending on the source angles and the corresponding deflection angles and wherein the surface profile of the first interface is determined depending on the first refraction angles, the surface profile of the second interface is determined depending on the second refraction angles, the surface profile of the third interface is determined depending on the third refraction angles and the surface profile of the fourth interface is determined depending on the fourth refraction angles.

13. The method as claimed in claim 12, wherein the refraction angles are predefined such that for electromagnetic radiation along a beam path the refraction angles are equal in magnitude.

14. The method as claimed in claim 10, wherein a Lambertian radiation distribution is predefined as the source radiation distribution.

15. The method as claimed in claim 10, wherein a Fresnelization is carried out when determining the surface profiles in the case of at least one of the interfaces.

16. The device as claimed in claim 8, wherein the radiation arrangement has a first radiation source and at least one second radiation source for generating the electromagnetic radiation to be deflected.
